(19) United States
(12) Patent Application Publication
(10) Pub. No.: US 2014/0140461 A1
(43) Pub. Date: May 22, 2014

(54) Magnitites Pycnonuclear Reactions within Electrochemical, Radioactive and Electromagnetic Medias

(71) Applicant: Reginald B. Little, Talahassee, FL (US)

(72) Inventor: Reginald B. Little, Talahassee, FL (US)

(21) Appl. No.: 13/987,298

(22) Filed: Apr. 25, 2006

Related U.S. Application Data
(60) Provisional application No. 60/674,473, filed on Apr. 25, 2005.

(51) Int. Cl. G21G 1/00

(52) U.S. Cl. CPC G21G 1/00
USPC 376/156

(57) ABSTRACT

The electrochemically active elements of the transition series include both the third, fourth and fifth d block elements, the lanthanides and the actinides. These transition elements have distinct electrochemistry for driving many chemical reactions, in particular the absorption of large volumes of hydrogen and the formation of various hydrides. In particular, Pd, Th, Ti, Ag, Au and La hydrides exhibit anomalous effects. The chemical reactions for forming, decomposing and rearranging the bonds of metal hydrides involve large energies. Furthermore these metal hydrides and mixtures are here demonstrated to exhibit greater strange cold nuclear reactions both cold fission and cold fusion. This invention provides magnetic, x-ray, laser irradiation, pressure, neutron beam, beta ray, alpha ray, gamma ray and catalytic technology for accommodating the special conditions for more controlled and accelerated cold nuclear reactions within the dense plasma (pycno) provided by the lattice of these metal hydrides. Under these conditions, the cold nuclear reactions are controllably enhanced to rates for practical energy sources but the very nonsynergistic nature of these pycnonuclear phenomena diminishes the possibility of runaway or explosive systems.

This application is in reference, response and fulfillment of the provisional application No. 60/674,473.

### FIELD OF THE INVENTION

The present invention involves a method and apparatus for the enhanced and controlled acceleration of cold nuclear phenomena. The present invention has particular applicability in selectively producing cold nuclear phenomena at high yields and reproducibly. It is important to note that based on the different mechanisms of pycnonuclear reactions (relative to thermonuclear reactions) the rates of pycnonuclear processes are intrinsically extremely slow relative to thermonuclear processes. This invention therefore implies no possibility of explosive technology or danger high energy chain reactions for any dangerous devices. This art introduces the possibility that major electric power plants may use giant magnets to enhance the slow nonsynergistic phenomena of pycnonuclear reactions for safe, beneficial and peaceful energy sources to better mankind and civilization. No conceivable weapons can be developed from this art. This art makes use of large power facilities of similar size and construction as current coal burning, hydroelectric and fission facilities for using the electricity from these facilities to create strong magnetic fields for affecting electrocatalytic low temperature nuclear reactions.

The invention provides a means of using external magnetic fields of intense static and dynamic durations, spatial and temporal natures to enhance, to stabilize, and to accumulate energy, and to correlate the properties of dense lattice plasma of transition metal hydrides for the more enhanced rates of cold nuclear reactions within the lattice plasma. The invention also makes use of x-ray and free electron laser technology in an innovative way by (for the first time) using the laser photons to rapidly heat and excite the metal electrodes for more efficient catalyzed activation for core electron excitation and fixation to important high spin (hybrid) transition metal hydride intermediary states for the stimulated, selective electrochemical activation of nuclear reactions to produce massive amounts of energy. The excited core electrons and protons within the metal hydride lattices are spin flipped by the external strong magnetic field to stabilize higher densities of high spin excited core atomic states. This invention further exploits x-ray, beta ray, alpha ray and gamma ray technology to drive plasmons, magnons, excitons and phonons in catalyst for the controlled metal interactions for facile hydride absorption, diffusion and condensation into deuterium and tritium; electron capture and/or expulsion by the nucleus (of other atoms); proton capture and/or expulsion from the nucleus (of other atoms); deuteron capture and/or expulsion from the nucleus (of other atoms); neutron absorption and/or expulsion from the nucleus of other atoms. This new art makes further use of high pressure technology to enhance these events for greater conditions for pycnonuclear reactions within the plasma of the metal hydride. The new art's use of laser and magnetic phenomena to generate high density of high spin core electronic states and species leads to accelerated nuclear phenomena within the atomic scale electric fields and it leads to enhanced the correlated interactions within the intense static and dynamic electric and magnetic fields. The new art also makes use of extreme nonequilibrium conditions in the conductive coils (Ag, Fe Co, Ni, Cu, Pd, ect . . . ) of strong DC magnets for generating these excited high spin core states of the transition metal for catalyzing nuclear reactions. The magnetic field moulds the Universe. Here the strong magnetic field is used to organize and stabilize multi excited, high spin core electronic states in order to link electronic dynamics to the nucleus and its nucleon dynamics for nucleosynthesis and generating huge sources of energy controllibly.

### BACKGROUND

The industrial and governmental potentials for these cold nuclear reactions encompass many uses as energy sources, isotopic sources, x-ray sources, gamma ray sources and neutron sources. The controlled release of fusion energy may resolve the energy needs of tomorrow.

Nuclear reactions generate millions of times more energy than comparible chemical reactions on a mass basis. A simple way to harness this energy would present a major discovery. Moreover based on hydrogen fusion to helium, such nuclear fusion provides an essentially unlimited supply of energy with on limited hazards of dangerous waste.

The new art presented here is inspired by the recent DOE consideration of cold fusion. (C. Choi, “Back to Square One”, Scientific American p. 21 Feb. 28, 2005)) After 15 years the US Dept of Energy is still inconclusive and indecisive concerning cold fusion. The panel of various experts and scientists were not able to affirm or dismiss the reality of cold fusion. On this basis, new techniques as in this presented new art may shift the evidence in favor of the reality of cold fusion phenomena.

Conventional physics holds that nuclear phenomena are limited to high temperatures of millions of degrees in Celcius or extreme gravitational and magnetic field (10¹² tesla) conditions as in neutron stars, pulsars or magnetars. This reasoning has been backed by thermonuclear weapons and theories of the sun and other stellar systems. The high temperatures needed to overcome columbic repulsion of nuclei are the cause of such large thermal needs for causing fusion. Fusion reactions have been documented in many laboratories by accelerating deuterium nuclei equivalent to speeds in particle accelerators. Such processes in cold matter are thought not possible due to thermalization before fusion. However in this new art, the large coulomb barrier is demonstrated to be surrounded by the intra atomic coulomb accumulation of huge electronic excitation.

Dr. Steven Jones claimed detection of neutrons from cold fusion experiments in 1989. Dr. Martin Fleischmann and Dr. Stanley Pons in March 1989 claimed room temperature cold fusion in hydrogen loaded palladium, producing excess energy. However, repeated attempts to reproduce their results have been difficult, controversial and confusing.

During the last 15 years more evidence has mounted for the case of cold fusion. Dr. Peter Hagelstein of Massachusetts Institute of Technology recommended a review of the cold fusion claims by DOE during the past year of 2004.

The panel consisted of nuclear physicists, electrochemists and materials scientists. On the basis of evidence presented in support and against cold fusion, the panel was split concerning whether cold nuclear reactions can actually take place. The panel cited discrepancies in interpreting data and experimental approaches. However, the panel did suggest future funding of cold fusion research.

The skepticism arises out of claims of heat productions far less than that required by such nuclear reactions. One critics of cold fusion claimed that there is not enough heat production beyond that of water hydrolysis. Furthermore, not enough fusion products have been observed to justify the claims. Tritium, helium and deuterium productions and data are lacking according to most critics. Fleischmann and Pons observed 10⁹ times less than theoretical levels of neutrons.

Critics express that the deuterium-deuterium distance in palladium is about 0.7 nm where as in D₂ this distance is 0.074 nm. For fusion, conventional theory requires a deuterium-deuterium distance of less than 1/10 the normal spacing in palladium. The compression of metal hydrides by 10 fold in length and 1000 in volume requires enormous pressures. The effective pressure binding in metals is orders of magnitude weaker than this needed compression of 1/10 the lattice spacing. However, critics who have cited this evidence against cold fusion have this perspective for bulk global compression of the metal lattice, which indeed is not possible under prevailing conditions and such bulk compression if possible would lead to explosive uncontrolled fusion reactions. In this new art here a more local (atomic scale) compressive perspective is envisioned with consequent self-limiting fusion and fission processes. In this invention, results of Little suggest that under magnetization, high temperature, and high external pressure such compression may be locally sporadically possible by internal electrochemical fields associated with the sd rehybridization of the metal lattice and the consequent confinement of e⁻, p⁺ into s orbitals whereby their proximity to the nucleus can cause their isolated compression for reverse beta phenomena. On the basis of the Little Effect, the cold nuclear reactions are not a result of the lattice directly compressing the hydrogen nuclei into helium nor are the cold nuclear reactions due to the protons being directly captured by the metal nuclei. On the basis of the Little Effect, the cold nuclear reactions occur indirectly by the lattice by spin and orbital phenomena, which torque e⁻ into p⁺ and nuclei within the lattice with enhancement by organization by spin and magnetism within the lattice and even greater enhancement by the impression of a strong external magnetic field. The resulting neutrons from the reverse beta process combine with protons and metal nuclei to form deuterium, tritium, helium and various other nuclides.

The muon is an elementary particle with mass 207 times that of electron. It was discovered in 1940. Muon catalysis has been proposed for driving cold fusion. During muon catalysis the heavy negatively charge muons act as heavy electron in binding deuterons at close enough space for fusion. However at the present time, muon production energy is more than the energy released during the resulting fusion.

Transition elemental materials and compounds thereof possess a wide variety of applications for electrochemical purposes due to their unique electronic structure and properties and chemical bonding of other elements in particular hydrogen. Current interests in these substances and materials reflect their unusual absorption of hydrogen, lithium, beryllium, boron, carbon, and nitrogen; their electric transport and conductivity, their large thermal transport, their unusual diffusion efficiency for these elements in particular hydrogen and its isotopes, their energetics, and their storage capacity for these lighter elements. It has been suggested that these compounds of the 2^{nd} d series provide highly dense environments for cold nuclear reactions but in a slow and sporadic manner.

The huge absorption of hydrogen by palladium was first noted during the late 1800s.

During the 1920s, German scientists, F. Paneth and K. Peters, claimed transmutation of hydrogen into helium within finely divided palladium at room temperature. They later retracted their claim based on mistaken background helium artifact. J. Tandberg of Sweden claimed in 1929 the fusion of hydrogen into helium in an electrolytic cell with palladium electrodes. His patent was rejected based on the work of Paneth and Peters.

Atkinson and Houtermans in 1929 first proposed the well accepted explanation that fusion is the energetic process within the sun.

Gamow and Teller (1938) noted the rate of thermonuclear reactions between two nuclei (unscreened) by the following equation:

R_{G}=nⱼ nⱼ exp(−τᵢⱼ) (16 Sᵢⱼ(T)_{G} rᵢⱼ·τᵢⱼ²)/[3^{5/2} π(1+δᵢⱼ)h]

Where τᵢⱼ=[π/2]^{2/3} [E_{G}/k_{B} T]^{1/3}

It is on this basis that thermonuclear fusion within the Sun and other stars is understood. This Gamow-Teller equation also provides theoretical basis for man-made thermonuclear devices.

The sun's interior supports hot fusion processes due to its large mass and the resulting gravity driving the release of latent energy with the resulting dissipation to thermal energy activating nuclear reactions. Its density at core is 1.56×10² g/cm³, its temperature is 1.56×10⁷ K and its internal pressure is over 3.4×10⁵ mbar.

White dwarf's are mature stars with I solar mass compressed to 5000 km for density beyond 10⁶ g/cm and temperatures of 10⁷-10⁹ K.

Supernovas are dying stars formed upon the energy loss becoming less than thermal output due to run away nuclear processes under huge gravity.

Schatzman (1948) reasoned that in some systems lowering of the coulomb potential barrier can occur under high density (>10⁸ g/cm³)

Cameron (1959) disclosed that a high density of electrons can also contribute to enhanced rates of nuclear reactions with lower temperature dependence and higher pressure dependence. For such screened fusion, the rates are expressed more like the following with an enhancement factor due to screening for lower temperature fusion relative to the Gamow-Teller rate above:

R_{screened}=nⱼ nⱼ [E_{G}/Eₛ]^{1/2} [exp(−πⱼ [E_{G}/Eₛ]^{1/2})] {(1.3 Sᵢⱼ(T)ₛₛ rᵢⱼ·)/[(1+δᵢⱼ)h]}

Where Eₛ=Zᵢ Zⱼ e²/Dₛ; Eₛ is the screening energy; and D is the distance of closes approach.

On the basis of the Schatzmann and Cameron electric screening, fusion reactions were determined theoretically to occur in dense cooler charged stellar bodies such as neutron stars, pulsars and magnetars. Many scientists reasoned that such electrical screening contributes to fusion processes in these cooler stellar bodies.

Brown dwarfs are objects of lighter mass than the sun, which results in the inability to create enough gravitational energy to power nuclear fusion so the gravity is balanced by electron degeneracy effects and thermal effects. Brown dwarfs have interior temperatures of 2,000,000 K and densities of 100-1000 g/cm ³.

Jovian planets such as Jupiter are now known to radiate IR radiation at higher levels than that received from sun. Planetary nuclear reactions have been suggested to power these effects. Interior temperatures of 5000-20,000 K, densities of 2.5 g/cm³ are common in these planets.

Neutron stars can result from white dwarfs of smaller mass than those forming supernovas. For the neutron star, 1 solar mass is compressed to 10 km. They are thought to have outer Fe crust of 100 m thickness and densities of 10⁴-10⁷ g/cm³. The high density supports electron capture and reverse beta for proton conversion to neutrons.

Pulsars are highly dense rapidly rotating neutrons stars (flashing radio waves) left over from supernovas.

Magnetars are types of rotating neutron stars (flashing x-rays) with huge magnetic fields, a trillion times the earth's field. Magnetars are formed from much bigger supernovas than pulsars.

Recently some scientists even reasoned that the ultrastrong magnetic fields of neutron stars and magnetars contribute to even greater screening and enahancement for greater fusion rates in these cooler dense stellar bodies. Many researchers have suggested and determined, magnetic field effects on pycnonuclear reactions occurring within strongly correlated dense charged plasma. In 1986, Khersonskii explored the catalysis of nuclear reactions of hydrogen in strong magnetic field. In 1990, Romonov determined reactive effects of nuclear reactions controlled by magnetic field action on ferromagnetic materials. In 1995, Sekershitskii considered the effect of strong magnetic field on energy yield of pycnonuclear reactions. In 2002, Romodanov determined that tritium generation in a glow discharge on hydrogen isotopes in magnetic field. In 2004, Kondratyev determined enhanced neutron capture reactions in strong magnetic fields of magnetars. These various examples involve a range of conditions of magnetic field strength, kinetic energy and potential energy factors.

More recently investigators have controversially considered, reasoned and speculated that electron dense media within some transition metal lattices may afford sufficient rare events for fusing H atoms and nuclei.

The magnetic field and temperatures within the metal lattice certainly do not approach stellar conditions. Certainly no terrestrial conditions may involve magnetic fields comparable to magnetars and neutron stars over large volumes or huge gravitational potentials as in stars, nor the thermal conditions of stars for large-scale uncontrolled fusions. For stellar systems, the thermodynamics is determined by the high temperature, strong coulomb force and ultrastrong magnetic field, and tremendous gravity. The metal lattice is much different from the stars and here it is suggested that the thermodynamics and kinetics of nuclear reactions are limited to different more local electrochemical phenomena. The electrochemical effects between dense e⁻ and p⁺ and metal nuclei cause local, isolated pycnonuclear reactions at the lower energy densities of the metal lattice relative to the much higher energy densities within the neutron stars and magnetars. On this basis, the metal lattice is more limited in the rates of nuclear reactions. It is on this basis that this new art poses no danger for explosive or dangerous uncontrolled low temperature fusion, this low temperature pycnonuclear process may therefore be self regulating.

Mott and Jones noted the ionization of hydrogen upon its absorption in to some metals.

Pines and Nozieres (1966) note the quantum nature of electron plasma of conduction electrons in d-band of metals.

Fowler and Smithrells classified metals according to hydrogen absorption ability. Cu, Fe, Ni, and Pt are poor hydrogen absorbers with increase absorption with pressures and temperatures. The good hydrogen absorbers are Pd, Th, Ti, and La which decrease absorption with temperature and pressure.

Tanaka (1981) provides a mechanism for hydrogen absorption in metals, (T. Tanaka M. Keita, D. Azofeifa Physical Review B 24, (40 (1981), p. 1771) demonstrating the mechanism of hydrogen absorption. Hydrogen absorption goes as square root of pressure. The absorption is understood as a cooperative condensation of hydrogen from gas like to liquid-like state.

Ichimura determines the importance of coulomb and exchange interactions between d electrons of metal and hydrogen solute.

Lachner realizes some type of attractive forces between absorbed hydrogen in some metal lattices. On the basis of the Little Effect, here it is suggested by this new art that such unusual attractive forces between the hydrogen atoms follows from spin and magnetics with the nuclei and electrons of the metal lattice.

Griessen and Feenstra determine the large volume changes of metals upon hydrogen absorption into metal lattices. Griessen and Feenstra (J. Phys. F: Met.Phys. 15 (1985) 1013) determined that unlike other metal hydrides, FeHₓ remains magnetic as hydrogen content increases. Most hydrides lose ferromagnetism and paramagnetism with greater hydrogen absorption. The volumes of hydrides change during hydrogen absorption (Peisl et al.). The lattice expansion involves roughly 2.9 angstroms cube per H atom. Westlake et al. determines volume expansion occurs also in transition metal alloys upon hydrogen absorption. There is a lower expansion in Sc and Y, but larger expansion in La, (4 Angstroms/H atom). There is a decrease in expansion along rare earth series. Actinides also have largeer expansion upon hydrogen absorption. The enthalpy change is proportional to volume change. Enthalpy change is related to fermi energy, where the LUMO of s character depends on band structure (band width) and low filling of conduction band. Hydrogen drops electrons in s band (LUMO) of metal leading to large energy of adsorption. In this new art, the localization of protons within s electronic states of the metal lattice is an important aspect of pycnonuclear phenomena in the metal lattice. Dropping electron leads to lattice expansion. It is important to note that such lattice expansion counters any critical bulk density of compression (> 1/1000 volume change) for critical explosion. The expansion on hydrogen absorption supports the idea presented here that the compression is individual and on an atomic scale at least for current attainable conditions.

F. A. Lewis [Pure and Appl Chem. 62(1990), p. 2091] notes the solubility of hydrogen in metals and they note that absorption embrittles metal. With increase hydrogen absorption the solution forms a compound phase. Hydrogen exists at octahedral position in loaded Pd and the hydride phase. Cu, Ag, Au, Pd are considered great absorbers. High pressure causes formation of beta hydride phases in poor absorbers: Fe, Rh, Mn, Cr, Rh.

In this work, Little says magnetic field may assist the pressure for increasing absorbance. High current densities correspond to high pressures for greater absorbance. The metal hydrides exhibit changes in resistivity with absorption. Ti and V embrittle upon H absorption desorption, but Pd does not embrittle.

Steven Jones (late 1980s) reasons the possible cold nuclear reactions in Jovian planets on the basis of Fe metal core and it's catalyze fusion of hydrogen in the cores of these planets.

Paul Palmer extends Jones planetary fusion to the earth. E. Paul Palmer in 1991 attempted evidence for p-d or d-d cold fusion in the earth. Fusion occurs in processes of fracture or strain rate. The earth contains high heat to ³He ratio. Non primordial He-3 is produced. Radioactivity can supply less than 5% of earth's heat budget. Convection suggests that primordial ³He should have been lost in outgassing.

Pons and Fleischmann (1989) claimed cold fusion during electrolysis of D₂O by Pd electrodes. The strange behavior of hydrogen in metals especially Pd, La, Ti, and Th includes the large absorbance of hydrogen (60-100 molar) for cathodically polarized electrodes. High cathodic overpotential increases hydrogen absorbance, possibly 1:1 H:Pd. The rapid isotopic diffusion (D_{D}⁺>D_{H}⁺>D_{T}⁺) is an anomaly. The ready isotopic separation in the metal media is another anomaly. The collective behavior of hydrogen ions in the metal hydride suggested provided by Pons and Fleischmann. They suggest that hydrogen ionization on dissolution, as first suggested by Mott. They determine that the hydride exists as a dense proton media in electron plasma (600-1000M). They reason that multibody interactions are necessary and that the protons act as classical oscillators in the lattice. They calculate that solvation of protons in the lattice occurs and they determined a negative overpotential with compression causing an increase in the solvation energy and the thermodynamics of the Born-Haber cycle. They determined that the larger solvation energy of proton ions is due to collective process.

In this work, Little expands on the suggestions of Pons and Fleischmann by demonstrating that even greater collective activity can be generated by much higher, excited high spin core states of the metal lattice. Little introduces spin and magnetics of high energy high spin core states for providing the extreme energetic conditions and magnetic spin environment for catalyzing nuclear transmutation at low temperature. On this basis, the prior work of Pons and Fleischmann and other investigators is explained by sporadic excitation of electrons with the inherent paramagnetism of the lattice stabilizing the excited states for very rare fusion events of hydrogen and electrons. In this new art expressed here strong external magnetic fields are demonstrated to better organize the metal lattice with the electrons and absorbed hydrogen for more efficient fusion and fission processes.

The mechanism of low temperature fusion within the metal lattices is based on the Little Effect. The Little Effect is spin induced orbital rehybridization and dynamics within a high spin polarized systems with sufficient thermal activation. On the basis of the Little Effect, valence excitation builds up huge Coulomb fields under antisymmetry within the external magnetic field. This antisymmetry in the strong external magnetic field allows many core electrons to be excited with the development of tremendous local intra-atomic Coulomb fields about metal nuclei within the metal lattice. Electrons and protons receive huge acceleration by such enormous Coulomb fields, especially electrons and protons confined within s orbitals of the metal atoms. Spin induced rehybridization dynamics of sd orbitals confine lattice protons and electrons into s like orbitals. Within the s orbitals, the electrons and protons experience tremendous nuclear coulomb forces for compression for reverse beta processes. These reverse beta processes on the basis of the new art here are accelerated by the external magnetic field in accord with spatial, temporal symmetry properties during weak interacting phenomena as put forth by Yang.

Pons and Fleischmann further note possible electrochemical loading or implantation of particles or photons for cold fusion effects. They note x-ray production during fusion.

In the new art here electromagnetic energy is used to excite core electrons for their intersystem crossing in the strong external magnetic field and stabilization of the resulting population inversion based on antisymmetry. The ability of antisymmetry to stabilize the core electron population inversion is motivated by its influence on florescence for phosphorescence and antisymmetry actually holding up the stars against gravitational collapse.

Fleischmann, Pons, and Preparata (Il Nuovo Cimento 107(1994), p. 143) suggest that the ionization of hydrogen requires strong electric fields to maintain this ionization in the lattice. Helium exists in an atomic state and not ionized. This difference in ionization potential is basis for estimating the range of local electric field strength within the metal lattice. Electric fields greater than 30 ev/A but less than 140 eV/A create holes or wells for protons from hydrogen. They reconcile the existence of deep well and facile motion of proton. They suggest that the existence of large clusters of H atoms or regions of ordered arrays of hydrogen in palladium. They determine that the collective, many-body phenomena arise from these arrays for cold fusion bursts. Holes from plasma electrons localized yet tightly bind to nuclei, localization requires the creation of lattice holes. They suggest that oscillation of d electrons generate the holes and wells. Here the Little effect determines greater oscillations of d electrons even by rehybridization dynamics of sd hybrid phenomena. The trapped hydrogen can be excited for escape and hole mobility. This explains both trapping and mobility of holes. Superradiance is a collective activity of electron and protons in the lattice. Hydrogen wave function and the electron wave function overlap for superraddiance coherent electromagnetic field. They suggest that the bosonic nature of deuteron versus fermion nature of hydrogen and tritium are important for accounting for differences in behaviors. They attempt to organize cold fusion events on the basis of superradiance. Overcoming the coulomb potential and asymptotic freedom is important for accounting for cold nuclear fusion. 10 fm separation is needed for fusion. Tunnelling would involve long distances through the coulomb barrier. There is a different manner of fusion in cold multibody vs hot two body. Unpredictablity follows from fusion rate dependence upon loading ratio, variability of phenomena, and burst in tritium and neutrons support this multibody effect. They determine that the coulomb screening of 100 eV is comparible to the hole depth. So the electron plasma creates hole depth and the hole depth are similar in energy to the coulomb barrier. Then electrons screen the coulomb barrier between the deuterons. Fleischmann and Pons suggest that a mechanism involving either neutral (neutron) or screened processes to avoid coulomb repulsion is impossible unless the mechanism show how shell neutrons are produced from deuterium in the lattice, or electrons can stick to deuterons at distances as small as a few 100 fm. They suggest that cold fusion involves phenomena that violate asymptotic freedom. They consider that nuclear events occur in the space time 10⁻¹² cm to 10⁻²¹ seconds compared to electronic 10⁻⁸ cm to 10⁻¹⁵ seconds. It is important to note that based on superraddiance, deuterons and electrons of the plasma violate principles of asymptotic freedom. Helium production without gamma emission requires very fast transfer of energy to the lattice.

Little says that the strong coupling of nuclei with excited core electrons provides such elimination of asymptotic freedom. Little accounts for these effects via multi-excited high spin core electrons through coulomb charge effects. Little accounts for the other effects by through bonds of the lattice in general.

John Dash claims the nucleosynthesis of Ag and Cd from Pd electrode during electrolysis in D₂O.

Zelansky explains cold fusion as the generation of ions in the metal lattice and spark generation causing fusion. Zelansky mentions the release of ionized deuterium from metal surfaces with possible clustering and sparking causing fusion.

S. Jones defends claims for geofusion on basis of unusual tritium levels in magmatic water from hot mantle tapping volcanoes. S. E. Jones (Tenth International Conference on Cold Fusion 2003. Cambridge, Mass.) Geofusion and Cold Nucleosynthesis. Piezofusion was suggested to occur within the metallic hydrogen core of Jupiter yielding excess heat. Paul Palmer extended this planetary fusion to the earth. Nuclear reactions are enhanced in metal deuterides. Jones claims fusion products from deuterium bearing metals in non-equilibrium conditions. Jones suggest similar processes deep in earth d+d→p+t. Also d+d→n+He-3. He-3 is released in volcanoes. He-3 is stored primordially from earth's formation. But tritium decays with half-life of 12.4 years, so it is a good test of the hypothesis of geofusion. If one can detect tritium from deep in earth emanating in magmatic gases and fluids, then cold fusion is occurring within the earth. Tritium measurements of volcanoe products provided positive test. Goff and McMurtry noted magmatic tritium should essentially be zero. Positive anomalies were observed from among ten volcanoes. Magmatic tritium was observed from Lilauea and Alcedo geysers all hot spot volcanoes produced by magma from plumes which rise hundreds of miles from the core mantle boundary. Others volcanoes of zero tritium were not hot spot volcanoes. Hot spots show higher He-3 to He-4. Natural geofusion occurs near the core of the earth in hot hydrogen bearing metals subject to off equilibrium conditions. Magmatic waters of Kilauea, Loihi and Icelandic volcanoes contain high levels of tritium.

H. Kozima claims the cold fission of Pd to Zn in electrolytic cell.

O. Reiferschweiler noted the changes in radioactivity of tritium upon internal binding to the lattice of titanium.

Hideo Kozima (Proc, ICCF9 (May 19-24, 2002, Beijing China) explored neutron wave function outside of nucleus. Nuclear fission of medium mass nuclei requires neutron excess of neutrons in nuclei, which is formed by formed by multi neutron absorption. The neutron drop, neutron valence band, and Dash's multi neutron absorption and beta decay of Pd and Ti deuterides are supporting evidences.

Shmal'ko and Solovey [J. Alloys and Compounds 231(1995), 856] show reversible sorption-desorptions of hydrogen. They determined that hydrogen exists as hydride to proton from electropositive to electronegative transition metals. They show the reversible formation-decomposition of transition metal hydrides. They determined that such formation-decomposition of hydrides in the lattice cause better catalytic activity, the appearance of monotonically excited state hydrogen and maximum hydrogen from freshly made palladium catalyst. They determined that metal hydride are great electrocatalysts with a decreased effectiveness of ionization against equilibrium hydrogen. They determined that this electrolyzed nonequilibrium hydrogen is harder to ionize in comparison to equilibrium hydrogen.

In this work, Little determines that the relative spin and orbital motion of electron and proton are important for explaining the difference in ionization of lattice hydrogen, catalytic properties of metal hydrides, electrochemical and electrocatalytic properties of metal hydrides and the pycnonuclear phenomena within the metal hydrides. Little determines that this hydrogen where electron and proton are not correlated condenses to deuterium in pycnomedia, this involves some strange state of protons relative electrons (ie relative spin). The e⁻, p⁺ in this state is confined to s orbitals wherein the proximity to metal nuclei activates the hydrogen into these nonequlibrium states.

Kozima claims that extranuclear wave functions of neutron overlap with external protons and electrons (occluded). Neutron interacts with external proton by strong interaction. Protons exist at interstial sites. Bloch wave functions describe the band states. Bloch wave functions ascribed to neutrons boundary layer density of neutrons and neutron drop formation as in neutron stars, coherence and increase in density of drop in analog. Kozima suggest that neutrons in conduction band react with nuclei and provide the bases for triggering reactions.

Tanaka and Ichimura noted possible incipient Rydberg States during absorptive processes in transition metal lattices.

R. J. Beuhler, G. Friedlander, and L. Friedman (1989) noted the collisional induced fusion reactions on impact of TiD for clusters D₂O (25-1300 molecules and energies of 200-325 keV).

Ichimure (1991) noted the possibility of other fusion reactions in ultrahigh pressure liquid metals. Reactions of deuterium with He-3 and reactions of Li-7 with He-4 in these liquid high pressure environments.

Little predicted and observed the magnetic organized cold nuclear reactions in the coils of strong DC magnets at the NHMFL. Little introduces magnetization of the metal lattice to even further enhance and control the pycnonuclear processes.

The physics of fusion within these various systems whether man-induced or celestial is understood on the basis of joint probability and contact probability theories.

These theories of joint probability depend on thermodynamic functions, macrostates and also microstates.

This dependence results in both and distinct vacuum dynamics and dynamics in dense environments for fusion. The vacuum systems are described by Gamow and Teller theories. Whereas the condensed are described by Schatzman and Cameron theories.

The enhancement factor relates the binary fusion rates of Teller with the screened fusion rates of Cameron.

In this new work, Little notes and reasons that current ideas and calculations make use of only the coulomb potential between nuclei and between nuclei and electrons for determining the screening parameter. Prior researchers assumed the electrons simply follow nuclei during screened collision fusion. Little notes the import of many electrons for effective screening and Little notes electron-electron repulsion is also important due to the smaller inertial effects of the less massive electrons. Electron-electron repulsive effects diminish screening. Little includes spin-spin and spin-orbital interactions for less e-e repulsion and stronger multi-electron screening within dense medias.

Little realized that magnetization reduces the electron-electron repulsion, nuclear-electron repulsion, and nuclear-nuclear repulsion.

Prior investigators have not considered electrons existing in orbitals and the nonclassical nature of screening electrons. Protons of the nucleus behave more nonclassically as nuclei approach, so that unpaired protons on nuclei have less repulsion. Paired electrons screen better and over longer distances. At shorter distance unpaired protons torque electrons for weak interaction. The weak interactions in addition to attractive electron-proton interactions overcome fewer electron-electron repulsion for greater screening. Little determines that weak interactions help diminish coulomb repulsion of both electrons and then nuclei for more efficiently screened cold fusion.

External magnetic fields magnetically polarizes fusing nuclei for closer approach under weak and external magnetic field torquing electrons in alignment with protons for stronger attractive (e⁻−p⁺) (weak plus electromagnetic) interactions than the coulomb repulsion of electron-electron and proton-proton.

The weak force between screening electrons and the protons allow a closer approach for strong interactions to take over leading to fusion. This effect predicted by Little accounts for formation of neutron stars. Also higher rates of reverse beta processes can occur under these dynamics.

This realization of external magnetic steered weak-force enhanced electron screening is consistent with the broken parity of the weak force interactions. The magnetic field breaks parity of interactions environment for greater weak force effects and greater enhancement factor from the screening electrons. This is consistent with observed and calculated spatial, temporal and matter-antimatter symmetry during weak processes by Yang.

The best know techniques for activating nuclear reactions within these media of transition metals involve the use of electrolytic cells and perhaps diamond anvil cells.

Even with these advancements of the older art, more development is in order for more accelerated nuclear events for potential use as energy source for potential use as sources of x-rays, gamma rays, neutrons, radioisotopes and related products.

This invention makes use of these older systems and other systems as sources of energy and nuclear reaction products by magnetically driven activation, electro driven activation, radiochemical activation and optically stimulated electrochemical transmutation of various nuclear structures.

Core electrons are the bridge to the nucleus. Magnetic field organizes to allow use of core electrons for driving nuclear phenomena. Little has been impressed by photoexcited state dynamics in magnetic field causing phosphorescence with up to 10 orders of magnitude difference in relaxation rates and excited state lifetimes. So magnetic field affecting dynamics of the valence states of atoms and molecules thereby affecting chemical reactions resulting in diamond. So now Little reasons that the magnetic field will affect core states involving much higher energies (beyond x-rays) for affecting internal atomic coulomb fields that pressure the nuclei or perturb them into nonequlibrium states for nuclear reactions. Little inverts the atom electronically via internal magnetization and the consequent antisymmetric metastability, thereby getting breaking asymptotic freedom to the nucleus via huge coulomb potential energies of excited states involving core electrons. Others have gotten to the nucleus via neutrons and high kinetic energies, but Little now about develops use of ultrastrong magnets to gradual build great Coulomb potential energies within atoms by successive excitation of Little with the steering and metastable coulomb build up provided by magnetic field. The strong magnetic field allows the gradual coulomb build up of tremendous internal coulomb potentials by stepwise energy input: electric current, photons, radioparticles. The magnetic field forms high spin states during this coulomb build up preventing relaxation. In confined systems the conservation of angular momenta limits changes of state, so an excited system is limited in relaxation by conserving angular momenta. The stepwise excitation of electrons within the metal lattice created an inverted state of huge coulomb potential. The antisymmetry in the strong magnetic field will not allow relaxation of such excited core electrons just as antisymmetry resists gravitational collapse of stars. Little excites and changes the momenta. The system cannot relax because in order to relax it needs to change its direction. It cannot do this without appropriate force acting on it. Building up energy and the resulting intensity leads to huge intra-atomic Coulomb potential energies associated with the electrons and protons around transition metal atoms. These huge intraatomic Coulomb energies approach nuclear energies. The electrons couple more strongly with the nucleus. The nucleus can then couple energy and momenta to electron cloud to change the electron cloud. The nucleus is many body. The electron cloud is many body. So these many bodies strongly couple as if they are one body. So the many body nucleus interacts with the many body electron cloud, breaking asymptotic freedom between nuclear dynamics and electronic dynamics. Nuclear transitions then change electronic transitions. This theory of Little explains the loss of asymptotic freedom suggested in cold fusion research. So that the high coulomb potential energy of electrons raises energy of the nucleus and the electron cloud relaxes to ground state of another element as the nucleus transforms to the different element. This explains breaking asymptotic freedom of nucleus and electrons by turning the atom inside out.

### BRIEF SUMMARY OF THE INVENTION

One of the improvements of the present invention is an apparatus for massively producing products of nuclear reactions by cold fission and fusion phenomena.

Another improvement of the invention is an apparatus for massively producing energy associated with nuclear reactions by controlled accelerated cold nuclear reactions.

Another improvement of the invention is an apparatus for massively producing energy and nuclear materials with less effort, expense and cost by making use of readily available neutrons, x-ray energy, gamma ray, beta ray, and alpha ray energy and matter from radioactive stockpiles.

Another improvement of this invention is an apparatus for the safer management, handling and transmutation of nuclear waste materials rather than storage at waste disposal sites. This technique will assist conversion of these energetic nuclei to less active nuclides.

The new art makes use of magnetic field, high electric current, alpha rays, gamma rays, beta rays, neutrons, high pressures, and x-rays for reducing the high temperature thermal conditions and the resulting unwieldly conditions for nuclear processes to cold processes. This apparatus and process lead to ease of combining, reforming and cracking nuclei for energy and valueable products.

Another improvement of the present invention is its applicability and industry for both heavy and light elements within a single pot synthesis. This new art provides magnetic fields, rays and particles for use with current electrochemical, catalytic, radioactive techniques with the enhancement of the ability of these techniques for generating and selecting isotopes and nuclear energies. The enhancement is a result of the stabilization of energy and uniformly coherent energy provided by the magnetic field, electromagnetic field and particle rays in comparison to thermal energy and phonons in older arts.

Another improvement of the current invention is the controllability of desired nuclear events. In particular, the magnetic stabilization for control of logic, reasoning, action, manipulation of process variables and feed-back control are feasible due to advantages provided by this new invention.

The nature of the magnetites pycnonuclear process eliminates explosive, uncontrollable runaway nuclear dangers. The magnetic field allows build-up of intratomic Coulomb potential by antisymmetry and organized weak interactions for nuclear transmutations. The intrinsic antisymmetry of such processes on the basis of temporal, spatial and matter symmetry provides nonsynergistic events such that the magnetic field enhances the weak interaction but the resulting weak interaction does not enhance the magnetization. The weak interaction and the resulting nuclear reaction are thereby effectively modulated by an external magnetic field.

Additional improvements and other features of the present invention will be put forth in the description which follows and in part will be apparent to those having ordinary skill in the art upon examination of the following or may be learned from the practice of the present invention. The progress and improvements of the present invention may be realized and ascertained as outlined in the appended examples and claims.

On the basis of the present invention, the foregoing and other advantages are achieved in part by a new apparatus for producing isotopes and nuclear energy. The apparatus consists of a reaction chamber having at least one electrode element or dense pycno media, at least one port for introducing target, at least one port for exhaust of product-target. Target is the element undergoing transmutation. The pycomedia is the lattice (usually a transition metal electrode) catalyzing the transmutation of the target species. The electrode element can be any element useful for applying electric stress for pycno conditions or a pycno-media for irradiation by alpha rays, beta rays, gamma rays, x-rays, electromagnetic radiation and/or neutrons. At least one laser radiation source may be disposed to the reaction chamber for rapidly exciting, heating, intersystem crossing and relaxing material and metal atoms. At least one magnetic field generator may be affecting the content of the reaction chamber for the magnetic stabilization and densification of various radicals and high spin states. At least one device for affecting the internal pressure of the electrolytic chamber or target material is involved. At least one laser IR heating source is arranged within the reaction chamber for selectively heating the metal catalysts. The thermal energy, catalyst, particle irradiation, x-ray, neutrons, laser fields, magnetic fields, pressure, and heating facilitate the cold nuclear conversion of target materials to desirable isotopes and excess energy.

In accordance with the current inventive apparatus, an IR heater is positioned near the reaction chamber that is capable of selectively interacting and heating the pycnomedia (electrode-catalysts). The IR advantageously allows the rapid selective input of heat to the pycnomedia for more efficient driving the media's internal diffusion, rehybridization, spin flipping, interconversion and nuclear processes.

In accordance with the current inventive apparatus, a laser for exciting and heating the pycnomedia is provided. The laser provides intense energy for exciting the pycno metal media into excitation, rehybridization, spin dynamics and electrochemical conversion.

In accordance with the current inventive apparatus, a magnetic generator is positioned about the pycnomedia that is capable of generating sufficient magnetic fields (static and/or dynamic) for confining, correlating, coordinating electrons, ions, nuclei of the dense plasma of the lycnomedia for pycnonuclear events and reactions. The resulting high density of high spin species within the pycnomedia produced by the heating element, laser excitation, and magnetic polarization provides a conducive environment for cold nuclear reactions. The magnetic field may be of sufficient intensity to create, stabilize, and drive intersystem crossing and rehybridizing dynamics of the excited state for creating important high spin hybridized excited electronic core states within the pycnomedia. The magnetic densification of these high spin core states facilitates the proximity of electron, proton, and neutrons within the pycnomedia for their collisional conversion to various nuclide states for the production of various nuclides and the release of excess energy. The magnetic field may be inclusive of neutron, beta particles, protons, and other leptons and baryons of spin.

Embodiments of the present invention include an apparatus comprising a pycnomedia, an electromagnetic source, a heating device, a pressure device, an exciting and/or stimulating laser, a neutron source, x-ray source, beta ray source, gamma ray source, alpha ray source, and a magnetic field generator. The IR beam from the source is energetically tuned and focused so as to be contacted with the pycnomedia to selectively heat the media controlling its temperature relative to the surrounding. The magnetic field is dynamically or statically tuned to sufficient intensity to affect the core electronic states of target and metal species. Magnetic field strengths from 1 to 1000 tesla are the range for this invention

The nature of the catalyst disposed to the reaction chamber comprises any transition metal and/or transition metal compound. Although allowed the catalyst may not be necessary due to the new influence of the neutrons for target electronic rehybridization, spin flipping and fixation.

Another aspect of the current invention is a new method of manufacturing various isotopes and radio nuclear products of the targets. The method involves contacting a target containing precursor and possibly a metal containing catalyst-electrode with an electromagnetic source for selectively heating and exciting the electrocatalytic media; use of beta rays, alpha rays, gamma rays, and/or x-ray to excite the electrocatalytic pycnomedia, applying magnetic fields to form, control and concentrate high spin state of core electrons of the atoms of the pycnomedia, thereby facilitating electronic excitation, rehybridization and spin dynamics of metal and target species for better densification and build up of internal atomic electrochemical fields within the metal atoms of the pycnomedia for cold nuclear events for isotopic product formations. The application of laser oscillating field to excite valence electrons for current induced build up of high spin core states and/or the applications of beta rays, alpha rays, gamma rays, and x-ray for the production of high spin core excited states about useful intermediary excited states may enhance the desired cold nuclear phenomena for specific product formation. All of these applications hereby listed enhance the selective formation of various nuclear structures.

The inventive method advantageously, selectively produces nuclear products isotopes, radioisotopes without the need for further purification thereby minimizing the loss due to purification processes and waste production. By electromagnetic radiation, particles, lasing and magnetic interactions, the product is not subject to adulteration during the fabrication, the yield and selectivity are also improved with lower energy input reducing the contamination, undesireds, pollutant generation and cost.

Embodiments of the current invention comprise forming isotopes and excess energy by contacting pycnomedia atoms and metal atoms with a magnetic field at suitable temperature (e.g. from −273.15° C. to 10,000° C.) and pressures of 0.001 to 100,000 atm with external laser and IR irradiation for enhanced photo-electro-catalytic excitation, rehybridization, spin dynamics (polarization) and densification that is aided by applying magnetic fields of at least 1-1000 tesla. The invention makes use of alpha ray, beta ray, gamma ray and neutrons with fluxes from 1000 to 10⁵⁰ particles per second per cm². The apparatus makes use of pressure transducers generating pressures from 1 atm to 50 GPa. The apparatus makes use of high electric currents with powers of more than 100 Mwatts.

Another aspect of the present invention is a method of using magnetic field for the selective production of isotopes and excess energy, the method facilitates the insitu single pot synthesis of various isotopic products.

Other aspects of the present invention are the production of various radioisotopes, with significant reduction of impurities.

Other aspects of the invention involve production of useful energy for powering the future.

Other aspects of the invention involves disposal of dangerous and harmful nuclear wastes.

Additional improvements of the present invention will become readily apparent to those skilled in this art from the following detailed description wherein embodiments of the present invention are described simply by way of illustrated of the best mode contemplated for carrying out the present invention. As will be realize, the present invention is capable of other and different embodiments, its several details are capable of modifications in various respects, all without departing from the present invention. Accordingly, the drawing and descriptions are to be regarded as illustrative in nature and not restrictive.

### DESCRIPTION OF THE INVENTION

The current invention focuses and resolves various issues associated with the production rate, yield and selectivity of isotopes, radioisotopes and excess energy associated with cold fission, fusion and nucleosynthesis by using intense static and dynamics magnetic fields with high electric currents, electromagnetic radiation, x-ray, gamma ray, beta ray, alpha ray and neutron irradiations for enhancing the dynamics of the pycnomedia's excitation, rehybridization, spin dynamics, diffusion and condensation during electrocatalytic, electrochemically, electromagnetically induced and/or radiation induced cold nuclear transmutations. The present invention contemplates a novel technique to selectively, efficiently and rapidly enhance the multielectronic excitation, spin and rehybridization and orbital dynamics of densely excited core electronic states of pycno media for accelerating, selecting and controlling energy release and product formation during consequent driven pycnonuclear reactions. The invention is simple in its design. It is however very effective in its use, overcoming the difficulties associated with building up internal atomic Coulomb potentials for affecting energetics and dynamics of the nucleus by creating metastable excited core electronic states by electronic spin and rehybridization dynamics upon exciting atoms, the implications from the instability of these intermediate high energy high spin dense core electronic states and the consequent dynamics created within the nucleus promise a new future in energy, environment and society. The consequences of better production rate and selectivity of energy and radio isotopes and even nuclear waste disposal with little required muscle outweigh the high electric current, radiation requirements and/or cooling requirements associated with the magnetic equipment and radiation sources of the invention. The present invention advantageously reduces or completely eliminates the need for harsh thermal conditions for necessary target transmutation associated with hot nuclear processes. The current invention if not operated properly may result in explosion. But proper operation can ensure controlled energy production and elemental transmutation under low thermal energy inputs. Such lower thermal requirements result in lower production expenses. In addition, the present invention by IR, x-ray, gamma ray, beta ray, neutrons and alpha ray provides efficient means of producing dense high spin, excited core electronic states for catalyzing nuclear processes, thereby eliminating high temperature collisional conditions for such nuclear processes. Moreover, the use of intense magnetic field and simply changing the nature of the field allow insitu simultaneous or sequential formations of heavy and light elements and isotopes within the same system. This invention discovers the use of magnetic energy for material and steering cold nucleo-syntheses, in particular the production of extremely important radioisotopes and huge amounts of energy. Furthermore, the present invention advantageously enhances the production rate and selective to levels commensurate with large-scale industrial and governmental uses.

In an embodiment of the current invention, the excitation provides a mechanism for increasing the energy of core electrons of the pycnomedia for forming dense volumes of excited high spin core electronics states. The core electronic excitation provides a controlled latent energy (potential energy) atmosphere for nucleosynthesis and transmutation rather than the intense thermal energies (kinetic energy) of older arts. The x-ray excitation allows selective excitation of particular metal elements catalyzing pycnomedia to higher latent energetic states for selective nucleosynthesis of particular isotopes. The target excitation in the lower ambient environments via the selective excitation with x-ray radiation results in less poisoning of the media, less side products and hot product formation under much lower temperatures.

In accordance with the current invention, radioisotopes and excess energy are formed by contacting a target with a particular pycnomedia containing precursors with an intense magnetic field. The field may be static for stable heavy isotope formation or dynamic for light and radioactive isotope formation. During the magnetically steered transmutation, a heating element may raise or lower the temperature for maintaining the temperature of the pycno media. Although the heating element is necessary it is important to note that in this invention the necessary temperature (273° C.<T<10,000° C.) is significantly less than the temperature in the older arts (i.e. Plasma T>1,000,000° C.). Heating is also accomplished via laser and electromagnetic radiation devices. During the cold nucleosynthesis a pycno agent (atoms, cluster, nanoparticles or bulk) may be supplied to facilitate the transmutation. During the transmutation, an x-ray and free electron laser is needed to rapidly heat, excite, and intersystem cross the pycnomedia causing the needed electronically induced nuclear decomposition, absorption, rehybridization, spin dynamics and condensation processes associated with nuclear interconversions. The lasing may be synchronized with the magnetization of the pycnomedia for efficient results. The IR, x-ray and laser excitation and the magnetization cause the excitation, promotion, stabilization, intersystem crossing and condensation of triplett, quartet and pentet high spin core electronic states of the atoms of the pycnomedia for more efficient creation of huge Coulomb potential fields within the atom's electronic structure for rearranging and inducing nuclear dynamics. During the transmutation, magnetic fields may be applied to the cavity in the reaction chamber to assist confinement and densification of high spin excited core electronic states. During the transmutation the pressure is controlled so as to assist production and stabilization of dense, high spin core electronic excitation and induced nuclear reactions. Higher pressure favors more intense internal atomic Coulomb fields for faster nuclear dynamics and heavier isotope formation. In part the type of isotope formed depends on the conditions of temperature; catalyst; pressure; IR energy; x-ray laser energy and intensity; magnetic field strength; and the consequent inverted pycnomedia's core electronic states.

The isotope formed in accordance with the present invention can take the form of heavy or light elemental states.

The apparatus for the production of compounds of isotopes and energy in the present invention includes a reaction chamber having at least one heating element, catalytic pycnomedia, pressure regulating device, external lasers (x-ray, gamma ray, IR, microwave, ect . . . ), radioactive particle sources, high electric current, neutron source and external magnetic field generator. In operation, the pycnomedia is introduced into the active states via excitation by laser, x-rays, alpha rays, beta rays, gamma rays, neutrons, electrical current, electromagnetic irradiations for electronic excitation and inversion of the resulting dense excited core electronic metal species with an external magnetic field. Hydrogen, Helium, lithium, beryllium, boron and carbon, oxygen, nitrogen, fluorine and other lighter elements are used to modulate the nuclear transmutations. Under these conditions, it is believed that the dense high spin core electronic state (causes a new electrocatalytic chemical states within the pycnomedia with new types of interatomic bonds and interactions not characteristic of conventional compounds of ionic and covalent nature. Interactions between atoms involve dense excited, high spin atomic species to form radical-radical unions. It is believed that contacting the resulting target atom with the catalytic high spin excited pycnomedia in the magnetic field, hydrogen, alpha, beta, gamma, neutrons facilitates (under lower temperature CVD conditions) the nuclear excitation, spin transitions and rehybridization of the nucleons of the target atoms on the basis of efficient magnetic-spin interactions between the external field and interactions between the pycno-metal media and the nucleus of the target atom for the enhanced fixation of the nucleus of the excited target atoms via the pycnomedia for high spin target states that lead to conversion among various nuclear states and transmutation of the target species. It is believed that the resulting triplett, quartet and pentet high spin nuclear states species from the intersystem crossing within the nucleus may be externally stabilized and stimulated by the forces of the surrounding electrons in the atom which are driven by external intense magnetic field, neutron, beta rays, alpha rays, gamma rays and x-ray radiations. These external conditions drive the formation of catalytic electronic high spin energetic states of the core electrons of the pycnomedia (nonequilibrium) which drives the nuclear states of the target for the selectively formation of radioisotopes. It is believed that the external pressure and magnetic field confine the target atom within the catalytic pycnomedia in ways to allow nuclear transmutations.

The inventive apparatus can take the physical form in a variety of parts and the arrangement of these parts. In FIG. 1, an apparatus according to the form of the current invention is illustrated. As shown in FIG. 1, the apparatus includes a reaction chamber and at least one laser, at least one heat element, e.g. the combination of the reaction chamber and heating element may be commercially available. The reaction chamber may be equipped with a resistance heater, an IR heater, exciting lasers and an inlet port for supplying target precursors, an outlet port and an encapsulating solenoidal magnet. The reaction chamber may be equipped with target gaseous precursors flowing to contact a electrochemical catalyst as with catalytic technology. The heating element and catalytic technologies may be of any design so long as it provides a sufficient thermal source of target and pycno-metal atoms. The reaction chamber may be connected to some technology for applying pressure. The reaction chamber includes at least one port for introducing the reactants and at least one port for exit of materials.

In the form of the present invention, the reaction chamber is in communication with the target and pycno-metal sources within or without the reaction chamber or with flowing target and metal precursors supplied by inlet ports. The target and metal sources include but are not limited to catalytic conversion. In the form of the current invention, the target and metal species flow is controlled by catalytic rate ect . . . In practice, the target and metal precursors may be diluted with background gases such as hydrogen, helium or argon or other reagent gases that are currently known to promote nuclear transmutation.

In an embodiment of the current art, the reaction chamber provides a space/time for the combination, rearrangement and decomposition of the nucleus of target precursors atoms under the influence of the densely excited high spin pycno media catalyst created by the magnetic environment and the exciting radiation and particles; the nuclear rehybridization and spin dynamics of the resulting target atoms; the diffusion of target species within the pycnomedia catalysts; and the transmutation of the target species into various isotopes. The excitation and magnetization allow the activation of targets and metals states electronically excited, electronically spin polarized, electronically inverted about various hybrid states by lasers, electronically confined by external fields and pressure for the electronically driven interconversion of isotopic states under lower temperature and pressure conditions relative to older arts. The reaction chamber should be large enough to allow the internal laser and particle irradiators. The reaction chamber should be shaped and sized so as to facilitate catalytic activity under lasers, x-rays, gamma rays, alpha rays, beta rays, neutrons, IR and magnetization. The reaction chamber should be of such to allow heating, cooling and/or pressurizing so as to facilitate the formation of densely excited core electronic states and subsequent nuclear interconversion. The reaction chamber should be of the form for sufficient residence of target and pycnometal species for efficient contact with the spin activating magnetic field, radiation, exciting lasers and the heating laser and IR sources for the formation and stabilization of desirable triplett, quartet and pentet target intermediary states. The reaction chamber should facilitate the intervention of external magnetic fields so as to confine paramagnetic high spin target species within the reaction regions for electronic interconversion between nuclear states substances.

The reaction chamber also includes at least one additional port, e.g. exit port for exhaust or to attach a pressure device in communication with the reaction chamber, e.g. vacuum pump to reduce pressure or to increase pressure.

In accordance with the current inventive apparatus, a catalyst or metal pycno agent may be disposed to the reaction chamber in the form of transition metal precursor compound or as a seed element in the targets precursors. The pycnocatalyst may be metal atom, cluster nanoparticle or bulk particles that are freely dispersed or confined to a substrate.

In an embodiment of the present invention, the catalyst provides of necessity a basis for electronically catalyzing target nuclear excitation, spin polarization and rehybridization dynamics. The catalyst may be in the form of atoms, clusters, nanoparticle or macroparticles. The catalyst may be transition metal or transition metal compounds. The catalyst may be localized on substrate or uniformly disposed to the reaction zone. The temperature is fine tuned to maximize the influence of the pycnocatalyst. The magnetic field is fine tuned to maximize the influence of the pycnocatalyst. The x-rays, alpha irradiation, beta irradiation, gamma irradiation, neutron irradiation are fine tuned to maximize the pycnocatalytic activity for transmutation of the target atoms. The laser excitation is fine tuned to maximize the influence of the pycnocatalyst. The pressure is fine tuned to maximize the influence of the pycnocatalyst. The IR is fine tuned to maximize the influence of the pycnocatalyst.

In accordance with the current inventive apparatus at least one internal set-up may exist within the reaction chamber for laser irradiation for rapid excitation. In the case of catalytic systems, at least one device may be present to laser irradiate the catalytic metal pycnomedia during their magnetization. An external laser may pump the target and metal atoms to create particle and/or photon assisted production and stabilization of high spin core electronic states of pycnomedia for enhanced catalytic driven interaction with the nucleus of the target species to cause its nuclear excitation and consequent transmutation. Any device capable of inverting the core electronic states of the pycno media is suitable for the present inventive apparatus. These devices include neutrons, rf and microwave sources that also affect spin dynamics of the pycnometal media and the nucleon spins. The strength of the lasing should be so as to affect significant number of metal pycnospecies and consequently target species for transmutation of the target.

In accordance with the present inventive apparatus, at least one device or source of an electromagnetic radiation (IR, rf, microwaves, infrared, ultraviolet, x-ray, ect . . . ) is externally irradiating the pycno media and selectively exciting the metal catalysts. The electromagnetic radiation is positioned outside the reaction chamber. Any device capable of the generation of a source of electromagnetic radiation radiation can be used in the present inventive apparatus. The electromagnetic radiation source may be continuous or pulsed also diffuse or focused. The energy of the electromagnetic radiation is such to selectively affect the metal atoms so as to allow chemical, magnetic and electronic processes associated with core states of the metal pycnomedia. In an embodiment of the current invention, the electromagnetic radiation irradiation provides a mechanism for selectively heating the metal instantaneously for nuclear decompositions, absorption, rehybridization, spin dynamics and interconversion among suitable hybrid nuclear states of target species. The electromagnetic radiation pulse duration and or energy may be adjusted to be compatibility with the confining and inverting external magnetic field. The electromagnetic radiation pulse duration and/or energy may be adjusted to optimize selective, massive chemical interconversion of nuclear states of target atoms. The electromagnetic radiation flux, pulse duration and/or energy may be adjusted to analyze, manipulate and control the selective target transmutation.

In accordance with the present inventive apparatus, at least one device or source of an alpha ray, beta ray, gamma ray and/or neutron ect . . . are externally irradiating the pycno media selective exciting the metal catalysts. The alpha ray, beta ray, gamma ray and/or neutron ect . . . are positioned outside the reaction chamber. Any devices capable of the generation of a source of alpha ray, beta ray, gamma ray and/or neutron ect . . . are can be used in the present inventive apparatus. The sources of alpha ray, beta ray, gamma ray and/or neutron ect . . . may be continuous or pulsed also diffuse or focused. The energies of the alpha ray, beta ray, gamma ray and/or neutron ect . . . are such to selectively affect the metal atoms so as to allow chemical, magnetic and electronic processes associated with core states of the metal pycnomedia. In an embodiment of the current invention, the alpha ray, beta ray, gamma ray and/or neutron ect . . . irradiations provide a mechanism for selectively exciting the metal instantaneously for nuclear decompositions, absorption, rehybridization, spin dynamics and interconversion among suitable hybrid nuclear states of target species. The alpha ray, beta ray, gamma ray and/or neutron ect . . . pulse durations and or energies may be adjusted to be compatibility with the confining and inverting external magnetic field. The alpha ray, beta ray, gamma ray and/or neutron ect . . . are pulses duration and/or energies may be adjusted to optimize selective, massive chemical interconversion of nuclear states of target atoms. The alpha ray, beta ray, gamma ray and/or neutron ect . . . fluxes, pulse durations and or energies may be adjusted to analyze, manipulate and control the selectively target transmutations.

In accordance with the present inventive apparatus, at least one device for generating magnetic field is placed near the reaction chamber. The device is placed external to the reaction chamber, attached on the outer surface or at a distance from the chamber. Any device capable of generating a magnetic field is suitable for this purpose. The source of magnetic field includes subatomic particles such as polarized and unpolarized neutrons. The source of magnetic field also includes dynamic fields associated with electromagnetic radiation.

In an embodiment of the present invention, the magnetic field provides a means for creating, stabilizing, controlling and interconverting, quartet, pentet, hexet, heptet nucleons target and core electrons of the pycnonuclear metal species within the laser cavity. Various devices may generate the magnetic field. The magnetic field intensity, direction and duration may be so as to maximize confinement, population inversion, rehybridization and chemical interconverison of target species. The magnetic field intensity, duration and direction may be synchronized with electromagnetic irradiation so as to confine, generate and accumulate triplett, quartet, pentet, hexet, heptet states of target and metal excited species. The magnetic field intensity, duration and direction may be synchronized with sources of alpha ray, beta ray, gamma ray and/or neutron ect rays so as to generate, confine and accumulate tripplett, quartet, pentet, hexet, heptet target and metal excited nuclear and core electronic species. The magnetic field may be adjusted with regard to heat. The magnetic field may be adjusted with regard to pressure. The magnetic field may be adjusted with regard to exciting lasers so as to control spin and orbital transitions. The magnetic field may be adjusted with regard to sources of alpha, beta, gamma and/or neutron radiations. The magnetic field may be adjusted with regard to catalyst.

The inventive apparatus described by way of the above embodiment can be used to mass-produce radioisotopes, such as C-13, N-15, O-18, I-131, Ir-192, B-10, Sr-89, Sa-153, Re-186, F-18, P-32. The inventive apparatus may be used to mass produce energy. The various features and advantages of the present invention will become more apparent and facilitated by a description of its operation. As described above, the present inventive apparatus includes a chamber having a heating element, target and metal source, lasers, electromagnetic sources, alpha, beta, gamma and/or neutron ect sources, internal laser cavity, and an external magnetic field generator.

Target precursors suitable for use in the practice of the present invention are in principle possibly all elements.

Metal precursors suitable for use in the practice of the present invention are transition metals and compounds of transition metals, in particular second series transition elements latter in this series like Ru, Rh, Ag, and Pd. Also alloys of transition metals.

The catalyst need not be in active form before entry into the chamber so long as it can be readily activated under reaction conditions.

In practicing the present invention, isotopes and energy are formed in the chamber by producing dense, excited high spin nuclear and electronic states of target and metal species from catalytic systems and other sources. Exciting the target and metal mixture provides some kinetic energy to facilitate events for subsequent nuclear interconversion. Modulating the pressure in the reaction chamber also facilitates collisional events for favorable high spin excited core electronic states of pycnometal media and induced excited nucleon states for catalyzed transmutation interconversion. Interactions between target and metal species allow some nuclear excitation, rehybridization and spin dynamics of target nuclear states for suitable cold nucleosynthesis and interconversion. Contacting target species (and may be metal atoms for indirect influence on carbon atoms) with an external magnetic field super-enhances the excitations, rehybridization and spill dynamics of nuclear states of the target species directly (via direct magnetization of target) and indirectly (via magnetization of metal and then metal target rehybridization and spin dynamics). The magnetization and more so the metal core-electronic excitation, rehybridization and spill dynamics induce transitions and high spin excited nuclear states of the targets. The production of these high spin target states is synchronized with the magnetic confinement by external field. The magnetic field captures high spin, excited species and confines within the reaction region. The laser excitation assists populationally inverts high spin core electronic states of the pycnomedia which drives target species about important excited, high-spin, hybrid nuclear states of the target states for diffusion, absorption and interconversion for the selective transmutation to various products.

Reaction parameters include to the particular target precursors; pycnocatalyst; precursor temperature; catalyst temperature; pressure; residence time; feed composition, including presence and concentration of any diluents (e.g. H, He, Li, Be, B, C, Ar) electromagnetic radiation energy, spin polarity, flux and direction; laser pump energy; laser cavity; oscillator conditions; alpha ray, beta ray, gamma ray and/or neutron radiation intensity; external magnetic field strength and direction. It is contemplated that the reaction parameters are highly interdependent and that the appropriate combination of the reaction parameters will depend on the precursor, catalyst, electromagnetic radiation, alpha ray, beta ray, gamma ray and/or neutron ray intensities, laser cavity, heating, pressure and magnetic field for the article intended to be fabricated.

In practicing the present invention, the isotopes and energy can be produced by providing target and metal species source; elevating the temperature to sufficient range tho less than in older art; contacting the target species and metal species at the elevated temperatures; controlling the pressure so as to selectively interconvert specific isotopes at the lowest pressure. Heavy isotopes are favored at lower pressures in strong static magnetic fields. Whereas light isotopes are favored in dynamic magnetic environments. The irradiation with electromagnetic radiation provides appropriate energy so as to facilitate electronic excitation. The contact of the target with transition metals pycnomedia in the presence of static or dynamic magnetic fields provides conditions for high spin core states of the pycnomedia and target species for formation, stabilization and interconversion of the nucleus of target species. The laser excitation of the target and metal atoms facilitates the electronic excitation, rehybridization and spin dynamics of the core of pycnometal and nuclear excitation and spin dynamics within the target atoms for isotope transmutation and excess energy releases. These activities may act for an effective amount of time. By an effective amount of time it is meant for that amount of time needed to produce mass quantities. The amount of time may be from hours to days depending on conditions.

The target concentration should be high enough to allow the electromagnetic radiation energy, spin polarity, flux and direction; laser pump energy; laser cavity; pressure; oscillator conditions; alpha, beta, gamma and/or neutron radiation intensity; external magnetic field strength and direction to maximize its transmutation to energy and products. The precise concentration will depend on the desired product.

The metal catalyst concentration should be high enough to allow the target, electromagnetic radiation energy, spin polarity, flux and direction; laser pump energy; laser cavity; pressure; oscillator conditions; alpha ray, beta ray, gamma ray and/or neutron radiation intensity; external magnetic field strength and direction to selectively form isotopes and/or release excess energy. The precise metal concentration will depend on the desired product. Electromagnetic radiation, alpha, beta, gamma and/or neutron irradiation and lasing allow lower metal and possibly no metal for gaseous and liquid products. More metal yield solid products.

The temperature should be high enough to allow the electromagnetic radiation energy, spin polarity, flux and direction; laser pump energy; laser cavity; pressure; oscillator conditions; alpha ray, beta ray, gamma ray and/or neutron radiation intensity; external magnetic field strength and direction to selectively produce energy and form isotopes. The precise temperature will depend on the desired product. The electromagnetic radiation may allow higher temperature without the need to use catalyst. Higher temperature and pressure may be bad due to collisional rehybridization and spin flipping of excited core states of pycno media. Electromagnetic radiation may allow lower temperature collisions may not be factors because core excited states are hard to change to rehybridize and spin flip low density of states.

The laser exciting should be at a wavelength that facilitates the rapid absorption and electronic transitions of the target and metal species for efficient electronic, chemical, transport and nuclear interconversion processes leading to excess energy and isotope transmutations. The wavelength, intensity, pulse width and duration are process variables that are fine tuned to the desired transmutation products.

The electromagnetic irradiation should be so as to facilitate the activation energy for electronic, chemical, transport and interconversion of core states of the pycnomedia to form spin pycnomedia states for catalyzing nuclear transitions of the target states for target transmutation and excess energy release at lower temperature ambient environments. This transmutation, cold fusion and/or cold fission in lower temperature ambient provides advantageous possibilities. The lower ambient temperature results in less excess energy input for producing nuclear energy solving the energy crisis, forming useful isotopes and eliminating nuclear waste instantly.

The pressure device should be in communication with the reaction chamber and adjustable for high pressure to vacuum so as to facilitate.

The magnetic field is used to create, stabilize and concentrate high spin core electronic states of the pycnomedia and states of the target. The magnetic field may separate high spin from low spin species, providing high density of high spin pycno media and target species for clustering of target and pycnomedial states for superraddiance and burst in controlled fashions for huge energy release and radioproduct formation at temperatures and pressures much less than older art. On the other hand, dynamic field provides conditions for fusion of light elements and formation of light isotopes.

It is contemplated that the chamber housing the target and metal atoms be maintained so that the heat, pressure, exciting laser, electromagnetic field, alpha ray, beta ray, gamma ray and neutron radiation, and magnetic field can influence these target and metal species. The heat (temperature) and pressure of the target and metal species are maintained below a certain range so as to reduce collisional rehybridization of pycnomedia and target species for selective isotope formation and controlled energy release.

In an embodiment of the present invention excess energy and radioisotopes can be produced by passing target and metal species through the apparatus having pycnomedia, electromagnetic radiation energy, spin polarity, flux and direction; laser pump energy; laser cavity; pressure; oscillator conditions; alpha, beta, gamma and/or neutron radiation intensity; external magnetic field strength and direction that stimulate isotope transmutation of target materials. It is believed that by this process both light and heavy isotopes may be formed in the reaction zone.

The present apparatus allows the selective formation of light and heavy isotopes and various controlled energetic production without much impurity. The greater transmutation rate relative to older allows kinetically entrained elimination of waste. This new art produces excited high spin nuclear states of target species at such high concentrations for rapid kinetically restricted transmutation and nuclear interconversion. The magnetic field suspends target species actively as they grow.

In accordance with an embodiment of the present invention the final isotopes may be removed, separated from the metal pycno media.

### Example

An apparatus was built by aligning the pycnocatalyst bed in a quartz tube within the furnace within a magnetic field source at National High Magnetic Field Laboratory. The pycnocatalyst was made by forming Fe/Mo nanoparticles from Fe/Mo cluster molecules. The Fe/Mo in the nanoparticles was roughly 1-2 nm. The pycnocatalyst was placed in a ceramic vessel housed within the reaction chamber. The pycnocatalyst bed was placed within the quartz tube having a length of 8 ft and diameter of 25 mm. The pycnocatalyst bed was arranged at a location of the quartz tube, where the tube wall was flattened (to form irradiation window) to facilitate the in-situ laser and electromagnetic irradiation of the interior. The quartz tube with the inserted pycnocatalyst bed was then located within the a specially designed furnace which contained two sets of diametrically aligned holes in the furnace walls at about halfway along its length. The hole pairs in the furnace walls define a line that intersect the axis of the tube furnace. The holes in the furnace allow irradiation and in-situ observation of the catalyst within the quartz tube as the furnace heats the quartz and catalyst for isotopic transmutation. One hole pair is for electromagnetic irradiation. The other hole pair is for gamma ray, alpha ray, beta ray and or neutron irradiation. The furnace was heated in the range of 25° C. to 1000° C. after the pressure in the tube was adjusted and a flowing atmosphere of Ar was established. After 10 minutes of Ar purging, Ar flow was stopped and hydrogen flow was started. After 10 minutes of purging with hydrogen, simultaneously precursor was introduced into the quartz tube and magnetic field from the superconducting magnet was directed onto the pycnocatalysts on the substrate. A laser beam and electromagnetic radiation were focused on the catalyst bed during the magnetization. For this particular example, the electromagnetic and laser beams were focused on the pycnocatalyst during catalytic interconversion and transmutation of the target species (Hydrogen). The electromagnetic radiation is deep penetrating and permeate the pycnocatalytic NP affecting both the electrons of absorbed target species and the pycnometal lattice. These electromagnetic radiation, magnet-electron interactions enhance electronic spin transitions of pycno-iron-molybdenum species that promote forming high spin core electronic states of Fe and Mo which are stabilized in the external magnetic field. These high spin excited core electronic states of Fe and Mo cause intense potential energy fields within these atoms which affect interstitial and hydride states. The protons and hydrogen atom states resonate within the orbitals of the metal atoms. Proton clusters organize, and concerted, correlated transmutations of p+e to neutron occurs by reverse beta process. The proton cluster and the dense electronic states overlap well for the confined protons leading to superradiant recombination of proton and electrons but the surrounding metal perturbs the recombination so the electron cannot form an orbit but approaches the proton close enough for weak interaction leading to reverse beta process. The strong magnetic field organizes spins and orbitals of electrons, protons and nuclei during such reverse beta processes. Such external magnetization is in accord with Yang's observed left-right spatial asymmetry of weak processes in magnetic environments. The resulting neutron burst transforms protons to deuterons. The neutrons further transform deuterons to tritons, which decay to helium-3. Unlike the gas hot fusion process. The lost asymptotic freedom results in the release energy dispersed to the whole lattice. With thermallization of neutrons and the release of gamma rays. The excess energy appears efficiently as thermal energy. During this process the Mo—Fe melts although the temperature is only 900 Celcius. The process and the released energy also melt ceramic materials and silica and silicon.

Various nuclear products have been detected during this process such as tritium, and helium by SIMS of the Fe—Mo catalyst. The Fe was converted to Mn and Mo converted Pd and Rh and Zr.

### Example #2

These novel spill induced orbital dynamics for novel magneto-catalytic phenomena were studied within the magnetized systems: water oxidation of copper and silver alloy metal. The water oxidation of Cu—Ag is extensively explored and developed here as more experimental evidence of the Little Effect. In particular, the DC magnets at the National High Magnetic Field Laboratory (NHMFL) in Tallahassee, Fla. were analyzed because such magnets operate by forcing huge electric currents through Cu—Ag coils by high volts to generate very strong magnetic fields. The Cu—Ag coils produce huge heat loads, which are removed by flowing large volumes of deionized water through and around the coils. In this work, these DC magnets were recognized as very unique environments to explore subtle magnetic field effects on chemical reactions due to the rapidly flowing, corroding water, Cu—Ag coils, strong magnetic field (up to 45 tesla), large electric field, pressure stresses and thermal stresses. The DC magnets operate at 403 volts and 74,000 amps. The coils are stacked, separated by thin insulating polymer and compressed tightly within the magnet. The coils consist of over 954 kg of Cu—Ag. More than 20,000 gallons per minute of highly deionized water flow through the holes in the coils to cool and maintain their temperature at 40-65° C. during operation. During operation, the water corrodes, oxidizes and dissolves the Cu—Ag coils. Magnetic field effects on electrochemistry of corrosion and dissolution are explored here. The predicted low rates of pycnonuclear reactions on the basis of the Little Effect were also explored within the Cu—Ag lattice. The Cu—Ag coils have varying lifetimes because various factors cause the arcing between coils and failure. Water samples were collected from the magnet during operation at various magnetic field strength, coil temperature and operation modes (ramping or stepping the field). The water samples were collected in acidic media to prevent the precipitation of the dissolved metals. The water was analyzed by inductively coupled plasma mass spectroscopy in order to correlate the relative amount of Cu and Ag solute dissolved. Isotopic analyses of the water samples were also done in order to measure ²H/¹H and ¹⁸O/¹⁶O ratios. The Cu—Ag coils were analyzed by SIMS and Rutherford back scattering spectroscopy to measure relative amounts of ²H and ¹H within the coils.

In addition to the novel electrochemistry, the extremely high current (74,000 amps), high potential (403V), strong magnetic field (45 tesla), pressure stress and thermal stress provide a very conducive environment for the debated and controversial cold fusion. In this work, it is important to note the much greater electric potential (403 volts) on the electrode, electric current (74,000 amps) through the electrodes and mass (954 kg) of the electrode in comparison to the lower power electrolytic systems of prior investigators exploring such low temperature pycnonuclear fusion. However unlike prior attempts of other investigators (Fleischmann and Pons) at exploring cold fusion, this system employs the highest possible current densities over much longer times with the added effects of strong magnetic field. The Cu—Ag coils studied in this work have been subjected to such high currents, strong magnetic field, deionized corrosive water, thermal stress and pressure stresses for over 2000 hours. Although it would be more conducive to study Pd under these extreme conditions the Cu—Ag coil currently used in the magnet was more readily available. The Ag exhibits to a lesser extent some of the anomalous properties with dissolved hydrogen. Cu contributes a 3d character in this Cu—Ag system in conjunction to debated Fe—H lattice for geothermal cold fusion in the earth's interior. The Cu alloy with Ag yields some useful 3d character to the metal matrix for novel spin-magnetics for pycnonuclear phenemena according to the Little Effect. Here in this work, under these extreme conditions this very interesting effect is observed. This ideal experimental environment for exploring cold fusion is deeply grounded in the prior theories of magnetic field effects on nuclear processes within stellar systems. Although the Little Effect introduces spin torque effect for altering e⁻ and p⁺ orbital dynamics for nuclear processes at moderate magnetic fields, many investigators have reasoned substantial magnetic contribution to the thermodynamics by ultrastrong magnetic fields in stellar bodies. Many researchers have suggested and determined, magnetic field effects on pycnonuclear reactions occurring within strongly correlated dense charged plasma.

The data from this work gives evidence for pycnonuclear reactions occurring within the Ag—H—Cu lattice under the sporadic thermal spikes and strong static continuous magnetization (45 tesla): 1) the demonstrated novel electrochemistry of Ag in the magnetic field; 2.) the thermal effects on Ag redox reactions; 3.) the accumulation/production of deuterium in Cu—Ag coil; 4.) accumulation of protium in Ag—Cu coil during magnet operation; 5.) strong magnetic field effects on electro chemistry of Cu—Ag; 6.) observed unusual Rh, Pd and Cd and Sn in coils by ICP-MS; 7.) deuterium, tritium and helium observed by SIMS in coils after use in strong magnetic field high current density; 8.) disappearing SIMS peaks after strong magnetization and observed appearance of new SIMS peaks at larger mass in SIMS; 9.) appearance of new peaks in SIMS after strong magnetization; 10.) fission by electron or neutron capture of Ag nuclei yielding masses of Kr+Ca, Na, observed in SIMS; 11.) Ti (localized-delocalized transformations) isotopes and Fe, Co, Ni isotopes exhibit unusual mass ratios in SIMS, before and after magnetization these metals are suspect for such magnetics and spin orbital effects for driving the pycnonuclear according to the Little Effect; 12.) observed unusual Ru, Rh, Pd, Ag, Cd, In and Sn in SIMS after prolong strong magnetization of Cu—Ag coils in water.

What is claimed:

1. A process for production of nuclear energy and isotopes said process comprising:
i. Contacting target atom with transition metal pycnomedia in a reaction zone, while holding the reaction zone at conditions suitable for electrochemical conversion, radiochemical conversion or photochemical conversion of the pycno media to excited core electronic states by applying strong external magnetic field in order to accelerate, enhance and select catalyzed nuclear transmutations and reactions of the target in the nonequilibrium transition metal lattice.
